(19) United States
(12) Patent Application Publication
(10) Pub. No.: US 2024/0313904 A1
(43) Pub. Date: Sep. 19, 2024

(54) METHOD FOR INFORMATION DETERMINATION, TERMINAL DEVICE, AND CHIP

(71) Applicant: GUANGDONG OPPO MOBILE TELECOMMUNICATIONS CORP., LTD., Dongguan (CN)

(72) Inventor: Shukun WANG, Dongguan (CN)

(21) Appl. No.: 18/677,199

(22) Filed: May 29, 2024

Related U.S. Application Data
(63) Continuation of application No. PCT/CN2021/135122, filed on Dec. 2, 2021.

(51) Int. Cl. H04L 1/1829; H04L 1/1812

(52) U.S. Cl. CPC H04L 1/1854; H04L 1/1812

(57) ABSTRACT

A method for information determination includes the following. A terminal device receives first scheduling signaling. The first scheduling signaling is scrambled by a first radio network temporary identity (RNTI), and the first scheduling signaling carries a hybrid automatic repeat request (HARQ) process identifier (ID) and a new data indication (NDI). The terminal device determines, according to the first RNTI and/or a previous scheduling mode corresponding to the HARQ process ID, whether the NDI is toggled and/or a value of the NDI.

### CROSS-REFERENCE TO RELATED APPLICATION(S)

This application is a continuation of International Application No. PCT/CN2021/135122, filed Dec. 2, 2021, the entire disclosure of which is incorporated herein by reference.

### TECHNICAL FIELD

This disclosure relates to the technical field of mobile communications, and specifically, to a method for information determination, a terminal device, and a chip.

### RELATED ART

In a new radio (NR) system, requirements on multicast services need to be supported in many scenarios, such as an internet of vehicles (IoV) and an industrial internet. Therefore, it is necessary to introduce a multimedia broadcast service (MBS) multicast service in the NR.

A hybrid automatic repeat request (HARQ) process identifier (ID) used for an MBS multicast service and an HARQ process ID used for a unicast service belong to the same ID space. The MBS service can be classified into MBS dynamic scheduling transmission and MBS semi-persistent scheduling (SPS) transmission in terms of a transmission type. The unicast service can be classified into unicast dynamic scheduling transmission and unicast SPS transmission in terms of a transmission type. Since data initial transmission and data retransmission are associated with the same HARQ process ID, when HARQ process IDs for these different transmission types are in conflict or the same, the terminal device cannot determine whether the scheduling by a network side is for the data initial transmission or the data retransmission, and thus the terminal device cannot correctly deal with data reception.

### SUMMARY

A method for information determination, a terminal device, and a chip are provided in embodiments of the disclosure.

A method for information determination provided in embodiments of the disclosure includes the following. A terminal device receives first scheduling signaling. The first scheduling signaling is scrambled by a first radio network temporary identity (RNTI), and the first scheduling signaling carries a hybrid automatic repeat request (HARQ) process identifier (ID) and a new data indication (NDI). The terminal device determines, according to the first RNTI and/or a previous scheduling mode corresponding to the HARQ process ID, whether the NDI is toggled and/or a value of the NDI.

A terminal device provided in embodiments of the disclosure includes a processor and a memory. The memory is configured to store computer programs, and the processor is configured to invoke and run the computer programs stored in the memory to cause the terminal device to perform the method for information determination above.

A chip provided in embodiments of the disclosure includes a processor. The processor is configured to invoke and run computer programs from a memory to enable a device equipped with the chip to perform the method for information determination above.

### BRIEF DESCRIPTION OF THE DRAWINGS

Accompanying drawings illustrated herein are used to provide a further understanding of the disclosure and form a part of the disclosure, and exemplary embodiments of the disclosure and elaboration thereof are used to explain the disclosure and do not constitute an improper limitation to the disclosure. The accompanying drawings are the following.

FIG. 1 is a schematic diagram illustrating an application scenario in embodiments of the disclosure.

FIG. 2 is a schematic diagram illustrating a protocol stack corresponding to a point-to-multipoint (PTM) mode and a point-to-point (PTP) mode in embodiments of the disclosure.

FIG. 3 is a schematic flow chart illustrating a method for information determination provided in embodiments of the disclosure.

FIG. 4 is a schematic structural diagram illustrating an apparatus for information determination provided in embodiments of the disclosure.

FIG. 5 is a schematic structural diagram illustrating a communication device provided in embodiments of the disclosure.

FIG. 6 is a schematic structural diagram illustrating a chip in embodiments of the disclosure.

FIG. 7 is a schematic block diagram illustrating a communication system provided in embodiments of the disclosure.

### DETAILED DESCRIPTION

The following will describe technical solutions of embodiments of the disclosure with reference to accompanying drawings. Apparently, embodiments described herein are some, rather than all of the disclosure. Based on the embodiments of the disclosure, all other embodiments obtained by those of ordinary skill in the art without creative effort shall fall within the scope of protection of the disclosure.

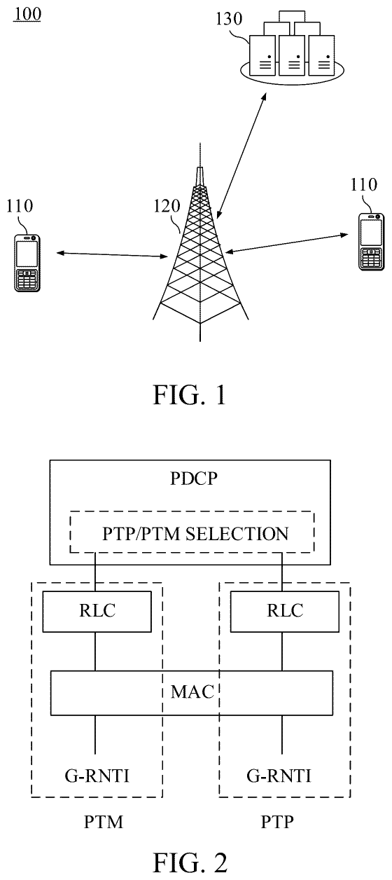

FIG. 1 is a schematic diagram illustrating an application scenario in embodiments of the disclosure.

As illustrated in FIG. 1, a communication system 100 may include a terminal device 110 and a network device 120. The network device 120 can communicate with the terminal device 110 via an air interface. The terminal device 110 and the network device 120 support a multi-service transmission.

It may be understood that, in embodiments of the disclosure, the communication system 100 is used simply for exemplarily illustration rather than limitation. That is, the technical solutions of embodiments of the disclosure are applicable to various communication systems. The various communication systems may include a long term evolution (LTE) system, an LTE time division duplex (TDD) system, a universal mobile telecommunication system (UMTS), an internet of things (IoT) system, a narrow band internet of things (NB-IoT) system, an enhanced machine-type communications (eMTC) system, a 5th generation (5G) communication system (also referred to as a new radio (NR) communication system), or a future communication system.

In the communication system 100 as illustrated in FIG. 1, the network device 120 may be an access network device that communicates with the terminal device 110. The access network device can provide a communication coverage for a specific geographic area and communicate with terminal devices 110 (e.g., a user equipment (UE)) in the coverage area.

The network device 120 may be an evolved NodeB (eNB or eNodeB) in the LTE system, a next generation radio access network (NG RAN) device, a gNB in the NR system, or a radio controller in a cloud radio access network (CRAN). Alternatively, the network device 120 may also be a relay station, an access point (AP), an in-vehicle device, a wearable device, a hub, a switch, a bridge, a router, or a network device in a future evolved public land mobile network (PLMN).

The terminal device 110 may be any terminal device, which includes, but is not limited to, a terminal device that connects to the network device 120 or other terminal devices in a wired or wireless manner.

For example, the terminal device 110 may be referred to as an access terminal, a UE, a subscriber unit, a subscriber station, a mobile station, a remote station, a remote terminal, a mobile device, a user terminal, a terminal, a wireless communication device, a user agent, a user device, etc. The access terminal may be a cellular radio telephone, a cordless telephone, a session initiation protocol (SIP) telephone, an IoT device, a satellite handheld terminal, a wireless local loop (WLL) station, a personal digital assistant (PDA), a handheld device with wireless communication functions, a computing device, other processing devices coupled with a wireless modem, an in-vehicle device, a wearable device, or a terminal device in a 5G network, a terminal device in a future evolved network, etc.

The terminal device 110 can be configured for device to device (D2D) communication.

The wireless communication system 100 may further include a core network device 130 that communicates with a base station. The core network device 130 may be a 5G core (5GC) device, an access and mobility management function (AMF) device, an authentication server function (AUSF) device, a user plane function (UPF) device, or a session management function (SMF) device. Optionally, the core network device 130 may also be an evolved packet core (EPC) device in the LTE network such as a session management function+core packet gateway (SMF+PGW-C) device. It may be understood that, the SMF+PGW-C device can implement functions of both SMF and PGW-C. With the evolution of the network, the core network device may also have other names, or a new network entity can be formed by dividing functions of the core network, which will not be limited herein.

Various functional units in the communication system 100 may establish a connection with one another via a next generation (NG) interface for communication.

For example, the terminal device establishes an air interface connection with the access network device via an NR interface to transmit user-plane data and control-plane signaling. The terminal device can establish a control-plane signaling connection with the AMF device via NG interface 1 (N1 for short). The access network device, e.g., a next generation wireless access base station (gNB), can establish a user-plane data connection with the UPF device via NG interface 3 (N3 for short). The access network device can establish a control-plane signaling connection with the AMF device via NG interface 2 (N2 for short). The UPF device can establish a control-plane signaling connection with the SMF device via NG interface 4 (N4 for short). The UPF device can exchange user-plane data with a data network via NG interface 6 (N6 for short). The AMF device can establish a control-plane signaling connection with the SMF device via NG interface 11 (N11 for short). The SMF device can establish a control-plane signaling connection with a policy control function (PCF) device via NG interface 7 (N7 for short).

FIG. 1 exemplarily illustrates a base station, a core network device, and two terminal devices. Optionally, the wireless communication system 100 may include multiple base stations and the other number of terminal devices that may be included in a coverage range of each of the multiple base stations, which will not be limited in embodiments of the disclosure.

It may be noted that FIG. 1 only illustrates a system to which the disclosure is applicable by way of example, and certainly, the method illustrated in embodiments of the disclosure may also be applicable to other systems. In addition, the terms “system” and “network” in this disclosure are often used interchangeably. The term “and/or” in this disclosure is simply an illustration of an association relationship of associated objects, indicating that three relationships can exist, for example, A and/or B, which can indicate the existence of A alone, A and B together, and B alone. In addition, the character “/” in this disclosure generally indicates that associated objects are in an “or” relationship. It may also be understood that the “indication” referred to in embodiments of the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation. It may also be understood that the “correspondence” mentioned in embodiments of the disclosure may represent a direct correspondence or indirect correspondence between the two, may also represent an associated relation between the two, or may further represent a relation of indicating and being indicated, a relation of configuring and being configured, or other relations. It may also be understood that, “predefinition” or “predefined rule” mentioned in embodiments of the disclosure may be implemented by pre-storing corresponding codes, tables, or other modes indicating relevant information in a device (for example, including a terminal device and a network device), and specific embodiments are not limited in the disclosure. For example, predefinition may refer to definition in a protocol. It may also be understood that, in embodiments of the disclosure, “protocol” may refer to a standard protocol in the field of communication, and may include, for example, an LTE protocol, an NR protocol, and a related protocol applicable to a future communication system, which is not limited in the disclosure.

In order to facilitate understanding of the technical solutions of embodiments of the disclosure, the following describes the related technologies of embodiments of the disclosure. The related technologies below as an optional solution may be arbitrarily combined with the technical solutions of embodiments of the disclosure, and any combination thereof may belong to the scope of protection of embodiments of the disclosure.

With the pursuit of speed, delay, high-speed mobility, energy efficiency, and the diversity and complexity of services in the future life, 3rd generation partnership project (3GPP) international standards organization starts to research and develop the 5G. Primary application scenarios of the 5G include enhance mobile broadband (eMBB), ultra reliable low latency communications (URLLC), and massive machine type communication (mMTC).

On the one hand, a demand for eMBB is growing rapidly with the goal of providing users with multimedia content, services and data. On the other hand, since eMBB may be deployed in different scenarios, such as indoor, urban, rural, and the like, the capabilities and demands vary greatly, therefore, it cannot be unconditionally determined and must be analyzed in detail in the context of specific deployment scenarios. Typical applications of URLLC include: industrial automation, power automation, remote medical operation (surgery), service safety and security, and the like. Typical features of mMTC include: high connection density, small data volume, delay-insensitive services, low cost and long lifetime of the module, and the like.

### Multimedia Broadcast Multicast Service (MBMS)

The MBMS is a technology in which data is transmitted from a single data source to multiple terminal devices through shared network resources. With the technology, multimedia services can be provided, network resources can be effectively utilized, and broadcasting and multicasting of multimedia services at a relatively high rate (e.g., 256 kbps) can be realized.

Due to relatively low spectrum efficiency of the MBMS, the MBMS is not sufficient to effectively carry and support operation of mobile TV services. Therefore, in LTE, 3GPP explicitly proposes to enhance support for a high-speed downlink MBMS service and determines design requirements on a physical layer and an air interface.

In 3GPP release 9 (Rel-9), an evolved MBMS (eMBMS) is introduced in the LTE. In the eMBMS, a concept of single frequency network (SFN), i.e., multimedia broadcast multicast service single frequency network (MBSFN), is proposed. In the MBSFN, a uniform frequency is used for simultaneous transmission of service data in all cells, but inter-cell synchronization is required to be ensured. In this way, overall signal-to-noise ratio distribution of the cells can be greatly improved, and accordingly spectrum efficiency can be greatly improved. In the eMBMS, broadcasting and multicasting of services are implemented based on an internet protocol (IP) multicast protocol.

In LTE or LTE-advanced (LTE-A), for the MBMS, there is only a broadcast bearer mode but no multicast bearer mode. In addition, reception of the MBMS service is applicable to a terminal device in an idle state or a connected state.

A concept of single cell point to multipoint (SC-PTM) is introduced in 3GPP Rel-13, and the SC-PTM is based on an MBMS network architecture.

In the MBMS, new logical channels are introduced, where the new logical channels include a single cell-multicast control channel (SC-MCCH) and a single cell-multicast transport channel (SC-MTCH). The SC-MCCH and the SC-MTCH are mapped onto a downlink-shared channel (DL-SCH). Furthermore, the DL-SCH is mapped onto a physical downlink shared channel (PDSCH). The SC-MCCH and the SC-MTCH are logical channels, the DL-SCH is a transport channel, and the PDSCH is a physical channel. A hybrid automatic repeat request (HARQ) operation is not supported in the SC-MCCH and the SC-MTCH.

In the MBMS, a new system information block (SIB) type, i.e., SIB20, is introduced. Specifically, configuration information of the SC-MCCH is transmitted via the SIB20, and there is only one SC-MCCH per cell. The configuration information of the SC-MCCH includes information such as a modification period of the SC-MCCH, a repetition period of the SC-MCCH, and a radio frame and a subframe for scheduling the SC-MCCH. Furthermore, 1) a boundary of the modification period of the SC-MCCH satisfies: SFN mod m=0, where SEN represents a system frame number of the boundary, and m represents the modification period (i.e., sc-mcch-ModificationPeriod) of the SC-MCCH configured in the SIB 20. 2) The radio frame for scheduling the SC-MCCH satisfies: SFN mod mcch-RepetitionPeriod=mcch-Offset, where SFN represents a system frame number of the radio frame, mcch-RepetitionPeriod represents a repetition period of the SC-MCCH, and mcch-Offset represents an offset of the SC-MCCH. 3) The subframe for scheduling the SC-MCCH is indicated via sc-mcch-Subframe.

The SC-MCCH is scheduled through a physical downlink control channel (PDCCH). On the one hand, a new radio network temporary identity (RNTI), i.e., single cell RNTI (SC-RNTI), is introduced to identify the PDCCH (e.g., an SC-MCCH PDCCH) for scheduling the SC-MCCH. Optionally, the SC-RNTI is fixed to a value FFFC. On the other hand, a new RNTI, i.e., single cell notification RNTI (SC-N-RNTI), is introduced to identify a PDCCH (e.g., notification PDCCH) indicating a change notification of the SC-MCCH. Optionally, the SC-N-RNTI is fixed to a value FFFB. Furthermore, the change notification may be indicated via one of 8 bits in downlink control information (DCI) 1C. In LTE, configuration information of the SC-PTM is based on the SC-MCCH configured via the SIB 20, and the SC-MCCH configures the SC-MTCH, where the SC-MTCH is used for service data transmission.

Specifically, the SC-MCCH transmits only one message (i.e., SCPTMConfiguration), where the message is used to configure the configuration information of the SC-PTM. The configuration information of the SC-PTM includes a temporary mobile group identity (TMGI), a session identifier (ID), a group-RNTI (G-RNTI), discontinuous reception (DRX) configuration information, and SC-PTM service information of a neighboring cell. It may be noted that a robust header compression (ROHC) function is not supported by the SC-PTM in Rel-13.

Downlink DRX of the SC-PTM is controlled by the following parameters: an onDurationTimerSCPTM, a drx-InactivityTimerSCPTM, an SC-MTCH-SchedulingCycle, and SC-MTCH-SchedulingOffset.

The timer onDuration TimerSCPTM is started upon satisfying [(SFN * 10)+subframe number] modulo (SC-MTCH-SchedulingCycle) 32 SC-MTCH-SchedulingOffset. The timer drx-InactivityTimerSCPTM is started upon receiving downlink PDCCH scheduling. A downlink SC-PTM service is received only when the timer onDuration TimerSCPTM or the timer drx-Inactivity TimerSCPTM is running.

SC-PTM service continuity adopts a concept of SIB15-based MBMS service continuity, i.e., “SIB15+MBMSInterestIndication” mode. Service continuity of the terminal device in an idle state is based on a concept of a frequency priority.

In the technical solution of embodiments of the disclosure, a new SIB (referred to as a first SIB) is defined, and the first SIB includes configuration information of a first MCCH. The first MCCH is a control channel for an MBMS service. In other words, the first SIB is used to configure configuration information of a control channel for an NR MBMS. Optionally, the control channel for the NR MBMS can also be referred to as an NR MCCH (i.e., the first MCCH).

Furthermore, the first MCCH is used to carry first signaling, and the name of the first signaling is not limited in embodiments of the disclosure. For example, the first signaling is referred to as signaling A. The first signaling includes configuration information of at least one first MTCH. The first MTCH is a traffic channel (also referred to as a data channel or a transport channel) for an MBMS service, and the first MTCH is used to transmit MBMS service data (e.g., NR MBMS service data). In other words, the first MCCH is used to configure configuration information of a traffic channel for the NR MBMS. Optionally, the traffic channel for the NR MBMS may also be referred to as an NR MTCH (i.e., the first MTCH).

Specifically, the first signaling is used to configure the traffic channel for the NR MBMS, service information corresponding to the traffic channel, and scheduling information corresponding to the traffic channel. Furthermore, optionally, the service information corresponding to the traffic channel includes, for example, a TMGI, a session ID, and other identification information for identifying services. The scheduling information corresponding to the traffic channel includes, for example, an RNTI used when MBMS service data corresponding to the traffic channel is scheduled, where the RNTI includes, for example, a G-RNTI and DRX configuration information.

It may be noted that transmission of both the first MCCH and the first MTCH is based on PDCCH scheduling. An RNTI used by the PDCCH for scheduling the first MCCH is a network-wide unique ID, i.e., a fixed value. An RNTI used by the PDCCH for scheduling the first MTCH is configured by the first MCCH.

It may be noted that the name of the first SIB, the name of the first MCCH, and the name of the first MTCH are not limited in embodiments of the disclosure. For ease of description, the first SIB may also be referred to as an SIB for short, the first MCCH may also be referred to as an MCCH for short, and the first MTCH may also be referred to as an MTCH for short. A PDCCH for MCCH scheduling (i.e., MCCH PDCCH) and a notification PDCCH are configured via the SIB, where a PDSCH used for MCCH transmission (i.e., MCCH PDSCH) is scheduled via DCI carried in the MCCH PDCCH. Furthermore, M PDCCHs for MTCH scheduling (i.e., MTCH 1 PDCCH, MTCH 2 PDCCH, . . . , MTCH M PDCCH) are configured by the MCCH, where a PDSCH used to transmit MTCH n (i.e., MTCH n PDSCH) is scheduled via DCI carried in MTCH n PDCCH, and n is an integer greater than or equal to 1 and less than or equal to M. The MCCH and the MTCH are mapped onto the DL-SCH. Furthermore, the DL-SCH is mapped onto the PDSCH. The MCCH and the MTCH are logical channels, the DL-SCH is a transport channel, and the PDSCH is a physical channel.

It may be noted that although the above solutions are described using an MBMS as an example, the description of “MBMS” can be replaced with description of “multimedia broadcast service (MBS)”. The embodiments of the disclosure are described with an MBS as an example, and the description of “MBS” can also be replaced with description of “MBMS”.

In an NR system, requirements on multicast services and broadcast services need to be supported in many scenarios, such as an internet of vehicles (IoV) and an industrial internet. Therefore, it is necessary to introduce an MBS multicast service and an MBS broadcast service in the NR. It may be noted that the MBS multicast service refers to an MBS service transmitted through multicasting. The MBS broadcast service refers to an MBS service transmitted through broadcasting.

In the NR system, for the MBS multicast service, the MBS service is transmitted to all terminal devices in a certain group. The terminal devices receive the MBS multicast service in a radio resource control (RRC) connected state, and the terminal devices can receive data of the MBS multicast service in a point-to-multipoint (PTM) mode or a point-to-point (PTP) mode. Referring to FIG. 2, in the PTM mode, for MBS service data, the corresponding scheduling information is scrambled by a G-RNTI configured by a network side, and in the PTP mode, for MBS service data, the corresponding scheduling information is scrambled by a cell-RNTI (C-RNTI).

For the MBS multicast service, after a base station receives an MBS service from a core network through a shared tunnel, the base station can transmit the MBS service to all terminal devices in a group through an air interface. The base station can transmit the MBS service to all the terminal devices in the group in the PTP mode and/or the PTM mode. For example, if the group includes terminal device 1, terminal device 2, and terminal device 3, the base station may transmit the MBS service to terminal device 1 in the PTP mode, transmit the MBS service to terminal device 2 in the PTP mode, and transmit the MBS service to terminal device 3 in the PTP mode. Alternatively, the base station may transmit the MBS service to terminal device 1 in the PTP mode, and transmit the MBS service to terminal device 2 and terminal device 3 in the PTM mode. Alternatively, the base station may transmit the MBS service to terminal device 1, terminal device 2, and terminal device 3 in the PTM mode. The MBS service can be transmitted between the core network and the base station through a shared general packet radio service (GPRS) tunneling protocol (GTP) tunnel, i.e., both the MBS service in the PTM mode and the MBS service in the PTP mode share the GTP tunnel. The base station transmits the MBS service data to UE1 and UE2 in the PTM mode, and transmits the MBS service data to UE3 in the PTP mode.

On the one hand, during transmission of an MBS service, there exists a scenario in which PTP is used for PTM retransmission. That is, for a transport block (TB) of the MBS service, the network side performs initial transmission in the PTM mode (i.e., scrambling corresponding scheduling information through a G-RNTI). If the terminal device fails to receive the TB and feeds back negative acknowledgement (NACK), the network side performs retransmission in the PTP mode (i.e., scrambling corresponding scheduling information through a C-RNTI). In this case, the initial transmission in the PTM mode and the retransmission in the PTP mode correspond to the same HARQ process ID and the same new data indication (NDI). That is, an HARQ process ID carried in scheduling signaling for the initial transmission is the same as an HARQ process ID carried in scheduling signaling for the retransmission, and an NDI carried in scheduling signaling for the initial transmission is the same as an NDI carried in scheduling signaling for the retransmission.

On the other hand, during transmission of the MBS service, an HARQ process ID used for the MBS service in dynamic scheduling transmission is specified by the network side and belongs to the same ID space as an HARQ process ID for a unicast service. If semi-persistent scheduling (SPS) is configured for the MBS service, an HARQ process ID for a transmission resource for each SPS is calculated by a formula, where the HARQ process ID and the HARQ process ID for the unicast service belong to the same ID space. As an example, an HARQ process ID for a transmission resource for MBS SPS can be calculated through the following formula: HARQ Process ID=[floor (CURRENT_slot×10/(memberOfSlotsPerFrame×periodicity))] modulo nrofHARQ-Processes, where CURRENT_slot=[(SFN×numberOfSlotsPerFrame)+slot number in the frame], and numberOfSlotsPerFrame refers to the number of consecutive slots per frame.

For configured downlink assignments with harq-ProcID-Offset, an HARQ process ID can be derived from the following equation: HARQ Process ID=[floor (CURRENT_slot×10/(numberOfSlotsPerFrame×periodicity))] modulo nrofHARQ-Processes+harq-ProcID-Offset, where CURRENT_slot=[(SFN×numberOfSlotsPerFrame)+slot number in the frame], and numberOfSlotsPerFrame refers to the number of consecutive slots per frame.

In summary, an HARQ process ID used for an MBS multicast service and an HARQ process ID used for a unicast service belong to the same ID space. The MBS service can be classified into MBS dynamic scheduling transmission and MBS SPS transmission in terms of a transmission type. The unicast service can be classified into unicast dynamic scheduling transmission and unicast SPS transmission in terms of a transmission type. Since data initial transmission and data retransmission are associated with the same HARQ process ID, when HARQ process IDs for these different transmission types are in conflict or the same, the terminal device cannot determine whether the scheduling by the network side is for the data initial transmission or the data retransmission, and thus the terminal device cannot correctly deal with data reception. To this end, the following technical solution of embodiments of the disclosure is proposed.

In In order to facilitate understanding of the technical solutions of embodiments of the disclosure, the technical solutions of the disclosure are described in detail below by means of specific embodiments. The related technologies above as an optional solution may be arbitrarily combined with the technical solutions of embodiments of the disclosure, and any combination thereof may belong to the scope of protection of embodiments of the disclosure. The embodiments of the disclosure include at least part of the following.

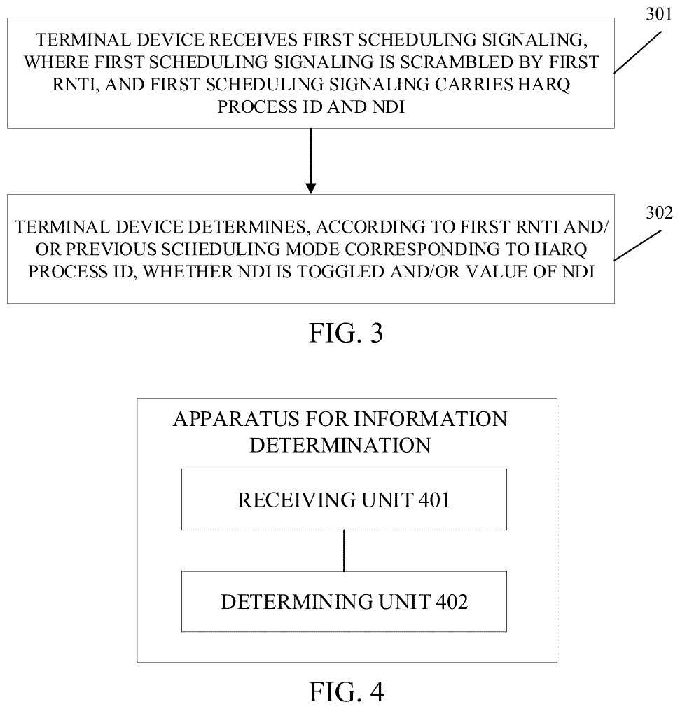

FIG. 3 is a schematic flow chart illustrating a method for information determination provided in embodiments of the disclosure. As illustrated in FIG. 3, the method for information determination includes the following.

301, a terminal device receives first scheduling signaling, where the first scheduling signaling is scrambled by a first RNTI, and the first scheduling signaling carries an HARQ process ID and an NDI.

In some optional implementations, before the terminal device receives the first scheduling signaling, a network configures, via RRC-specific signaling, configuration information for MBS service transmission to the terminal device. The configuration information includes, for example, a TMGI, a G-RNTI, a common frequency-domain position for MBS reception, an HARQ feedback mode, and a data transmission architecture mode. The HARQ feedback mode may be, for example, an NACK only based feedback mode (NACK only based HARQ feedback), or an acknowledgement (ACK)/NACK feedback mode (ACK/NACK based HARQ feedback). The data transmission mode may be, for example, a packet data convergence protocol (PDCP) anchor protocol stack mode, a data architecture transmission mode of PTP for PTM retransmission, etc.

302, the terminal device determines, according to the first RNTI and/or a previous scheduling mode corresponding to the HARQ process ID, whether the NDI is toggled and/or a value of the NDI.

In embodiments of the disclosure, the first scheduling signaling may be DCI, i.e., the DCI is scrambled by the first RNTI. The first scheduling signaling is used to schedule first data, where the first scheduling signaling carries the HARQ process ID and the NDI. The HARQ process ID is an HARQ process ID associated with the first data, and the NDI indicates whether the first data is newly-transmitted data or retransmitted data. However, since HARQ process IDs for different transmission types may be in conflict or the same, the terminal device determines, according to the first RNTI and/or the previous scheduling mode corresponding to the HARQ process ID, whether the NDI is toggled and/or the value of the NDI, and thus determines whether the first data is newly-transmitted data or retransmitted data.

In embodiments of the disclosure, a scheduling mode may be: scheduling scrambled by a C-RNTI, scheduling scrambled by a G-RNTI, MBS SPS grant, scheduling scrambled by a group-configured scheduling-RNTI (G-CS-RNTI), unicast SPS grant, or scheduling scrambled by a CS-RNTI. The MBS SPS grant corresponds to (or is consistent with) the scheduling scrambled by the G-CS-RNTI, and the unicast SPS grant corresponds to (or is consistent with) the scheduling scrambled by the CS-RNTI. The scheduling scrambled by the C-RNTI can be understood as unicast dynamic scheduling, and the unicast SPS grant and the scheduling scrambled by the CS-RNTI can be understood as unicast SPS. The scheduling scrambled by the G-RNTI can be understood as MBS dynamic scheduling, and the MBS SPS grant and the scheduling scrambled by the G-CS-RNTI can be understood as MBS SPS.

### Solution 1

In some optional implementations, the terminal device determines that the NDI is toggled, in the case that the first RNTI is a C-RNTI and the previous scheduling mode corresponding to the HARQ process ID is scheduling scrambled by a G-RNTI, MBS SPS grant, or scheduling scrambled by a G-CS-RNTI.

### Solution 2

In some optional implementations, the terminal device determines that the NDI is toggled, in the case that the first RNTI is a G-RNTI and the previous scheduling mode corresponding to the HARQ process ID is MBS SPS grant, scheduling scrambled by a G-CS-RNTI, unicast SPS grant, or scheduling scrambled by a CS-RNTI.

### Solution 3

In some optional implementations, the terminal device determines that the NDI is toggled, in the case that the first RNTI is a CS-RNTI and the previous scheduling mode corresponding to the HARQ process ID is MBS SPS grant or scheduling scrambled by a G-CS-RNTI.

In some optional implementations, the terminal device determines that the NDI is un-toggled and/or the value of the NDI is fixed to 1, in the case that the first RNTI is the CS-RNTI.

### Solution 4

In some optional implementations, the terminal device determines that the NDI is toggled, in the case that the first RNTI is a first G-RNTI and the previous scheduling mode corresponding to the HARQ process ID is scheduling scrambled by a second G-RNTI.

### Solution 5

In some optional implementations, the terminal device determines that the NDI is toggled, in the case that the first RNTI is a first G-CS-RNTI and the previous scheduling mode corresponding to the HARQ process ID is scheduling scrambled by a second G-CS-RNTI or second MBS SPS grant.

In some optional implementations, the terminal device determines that the NDI is un-toggled and/or the value of the NDI is fixed to 1, in the case that the first RNTI is the first G-CS-RNTI.

In the above solutions, if the terminal device determines that the NDI is toggled, data scheduled by the first scheduling signaling is considered as the newly-transmitted data. If the terminal device determines that the NDI is un-toggled and/or the value of the NDI is fixed to 1, the data scheduled by the first scheduling signaling is considered as the retransmitted data. The terminal device can correctly receive the data according to the determination of whether the NDI is toggled and/or the value of the NDI.

In some optional implementations, the terminal device transmits first information to a network device, where the first information is used by the network device to perform data scheduling. The first information includes first indication information and/or second indication information. The first indication information indicates a priority relationship between at least two of: scheduling scrambled by a C-RNTI, scheduling scrambled by a G-RNTI, MBS SPS grant, scheduling scrambled by a G-CS-RNTI, unicast SPS grant, or scheduling scrambled by a CS-RNTI. The second indication information indicates at least one of: a priority relationship between scheduling scrambled by different G-RNTIs, a priority relationship between different MBS SPS grants, or a priority relationship between scheduling scrambled by different G-CS-RNTIs. In this way, the network device can reasonably perform data scheduling according to the first information given by the terminal device.

In the above solutions, the first information may be carried in RRC-specific signaling, i.e., the terminal device indicates to the network side the priority relationship between scheduling modes via the RRC-specific signaling.

The technical solutions of the embodiments of the disclosure are exemplified below in connection with specific application examples.

### Application Example 1

The terminal device receives DCI (the DCI carries an HARQ process ID and an NDI) scrambled by a C-RNTI, and if a previous scheduling mode corresponding to the HARQ process ID is scheduling scrambled by a G-RNTI, MBS SPS grant, or scheduling scrambled by a G-CS-RNTI, the terminal device considers that the NDI corresponding to the HARQ process ID in the DCI scrambled by the C-RNTI is toggled, regardless of the value of the NDI in the DCI scrambled by the C-RNTI.

### Application Example 2

The terminal device receives DCI (the DCI carries an HARQ process ID and an NDI) scrambled by a G-RNTI, and if a previous scheduling mode corresponding to the HARQ process ID is MBS SPS grant, scheduling scrambled by a G-CS-RNTI, unicast SPS grant, or scheduling scrambled by a CS-RNTI, the terminal device considers that the NDI corresponding to the HARQ process ID in the DCI scrambled by the G-RNTI is toggled, regardless of the value of the NDI in the DCI scrambled by the G-RNTI.

### Application Example 3

For one or more MBS SPS, the network side configures for each MBS SPS an HARQ ID offset for computing an HARQ process ID, to ensure that an HARQ process ID for unicast SPS and an HARQ process ID for MBS SPS are different and an HARQ process ID for MBS SPS and an HARQ process ID for another MBS SPS are different.

The terminal device receives DCI (the DCI carries an HARQ process ID and an NDI) scrambled by a CS-RNTI, and if a previous scheduling mode corresponding to the HARQ process ID is MBS SPS grant or scheduling scrambled by a G-CS-RNTI, the terminal device considers that the NDI corresponding to the HARQ process ID in the DCI scrambled by the CS-RNTI is toggled, regardless of the value of the NDI in the DCI scrambled by the CS-RNTI. Alternatively, the terminal device receives the DCI (the DCI carries the HARQ process ID and the NDI) scrambled by the CS-RNTI, and the terminal device considers that the NDI corresponding to the HARQ process ID in the DCI scrambled by the CS-RNTI is un-toggled and/or the value of the NDI is fixed to 1.

### Application Example 4

The terminal device receives DCI (the DCI carries an HARQ process ID and an NDI) scrambled by a G-RNTI-1, and if a previous scheduling mode corresponding to the HARQ process ID is scheduling scrambled by a G-RNTI-2, the terminal device considers that the NDI corresponding to the HARQ process ID in the DCI scrambled by the G-RNTI-1 is toggled, regardless of the value of the NDI in the DCI scrambled by the G-RNTI-1.

### Application Example 5

The terminal device receives DCI (the DCI carries an HARQ process ID and an NDI) scrambled by a G-CS-RNTI-1, and if a previous scheduling mode corresponding to the HARQ process ID is scheduling scrambled by a G-CS-RNTI-2, the terminal device considers that the NDI corresponding to the HARQ process ID in the DCI scrambled by the G-CS-RNTI-1 is toggled, regardless of the value of the NDI in the DCI scrambled by the G-CS-RNTI-1. The terminal device encounters MBS SPS-1 grant, and if a previous scheduling mode corresponding to an HARQ process ID is scheduling scrambled by MBS SPS-2 grant, the terminal device considers that the NDI corresponding to the HARQ process ID corresponding to MBS SPS-1 grant is toggled. Alternatively, the terminal device receives the DCI (the DCI carries the HARQ process ID and the NDI) scrambled by the G-CS-RNTI-1 or encounters the MBS SPS-1 grant, and the terminal device considers that the NDI corresponding to the HARQ process ID in the DCI scrambled by the G-CS-RNTI-1 is un-toggled and/or the value of the NDI is fixed to 1.

Exemplary embodiments of the disclosure has been described in detail above in connection with the accompanying drawings. However, the present disclosure is not limited to the details of the above embodiments. Various simple modifications can be made to the technical solution of the disclosure within the scope of the technical concept of the disclosure, and such simple modifications shall be within the protection scope of the present disclosure. For example, it is to be noted that, all the technical features described in the above embodiments can be combined with each other in any proper manner without conflict. In order to avoid unnecessary repetition, various manners of combination will not be elaborated in the disclosure. For another example, various embodiments of the disclosure can also be randomly combined without departing from the spirit of the present disclosure, and such combination should also be regarded as content disclosed by the present disclosure. For another example, various embodiments and/or technical features of the various embodiments may be implemented in any combination with the related art without conflict, and technical solutions thus obtained shall also fall within the protection scope of the disclosure.

It may also be understood that, in various method embodiments of the disclosure, the magnitude of a sequence number of each of the foregoing processes does not mean an execution order, and an execution order of each process may be determined according to a function and an internal logic of the process, which shall not constitute any limitation to an implementation process of embodiments of the disclosure. In addition, in embodiments of the disclosure, the terms “downlink”, “uplink”, and “sidelink” indicate a transmission direction of a signal or data, where “downlink” indicates that a transmission direction of a signal or data is a first direction from a station to a UE in a cell, “uplink” indicates that a transmission direction of a signal or data is a second direction from a UE in a cell to a station, and “sidelink” indicates that a transmission direction of a signal or data is a third direction from UE1 in a cell to UE2 in a cell. For example, a “downlink signal” indicates that a transmission direction of the signal is the first direction. Furthermore, in embodiments of the disclosure, the term “and/or” herein only describes an association relationship between associated objects, which means that there can be three relationships. Specifically, A and/or B can mean A alone, both A and B exist, and B alone. Besides, the character “/” herein generally indicates that the associated objects are in an “or” relationship.

FIG. 4 is a schematic structural diagram illustrating an apparatus for information determination provided in embodiments of the disclosure. The apparatus for information determination is applied to a terminal device. As illustrated in FIG. 4, the apparatus for information determination includes a receiving unit 401 and a determining unit 402. The receiving unit 401 is configured to receive first scheduling signaling, where the first scheduling signaling is scrambled by a first RNTI, and the first scheduling signaling carries an HARQ process ID and an NDI. The determining unit 402 is configured to determine, according to the first RNTI and/or a previous scheduling mode corresponding to the HARQ process ID, whether the NDI is toggled and/or a value of the NDI.

In some optional implementations, the determining unit 402 is configured to determine that the NDI is toggled, in the case that the first RNTI is a C-RNTI and the previous scheduling mode corresponding to the HARQ process ID is scheduling scrambled by a G-RNTI, MBS SPS grant, or scheduling scrambled by a G-CS-RNTI.

In some optional implementations, the determining unit 402 is configured to determine that the NDI is toggled, in the case that the first RNTI is a G-RNTI and the previous scheduling mode corresponding to the HARQ process ID is MBS SPS grant, scheduling scrambled by a G-CS-RNTI, unicast SPS grant, or scheduling scrambled by a CS-RNTI.

In some optional implementations, the determining unit 402 is configured to: determine that the NDI is toggled, in the case that the first RNTI is a CS-RNTI and the previous scheduling mode corresponding to the HARQ process ID is MBS SPS grant or scheduling scrambled by a G-CS-RNTI; or determine that the NDI is un-toggled and/or the value of the NDI is fixed to 1, in the case that the first RNTI is the CS-RNTI. In some optional implementations, the determining unit 402 is configured to determine that the NDI is toggled, in the case that the first RNTI is a first G-RNTI and the previous scheduling mode corresponding to the HARQ process ID is scheduling scrambled by a second G-RNTI.

In some optional implementations, the determining unit 402 is configured to: determine that the NDI is toggled, in the case that the first RNTI is a first G-CS-RNTI and the previous scheduling mode corresponding to the HARQ process ID is scheduling scrambled by a second G-CS-RNTI or second MBS SPS grant; or determine that the NDI is un-toggled and/or the value of the NDI is fixed to 1, in the case that the first RNTI is the first G-CS-RNTI.

In some optional implementations, the apparatus further includes a transmitting unit. The transmitting unit is configured to transmit first information to a network device, where the first information includes first indication information and/or second indication information. The first indication information indicates a priority relationship between at least two of: scheduling scrambled by a C-RNTI, scheduling scrambled by a G-RNTI, MBS SPS grant, scheduling scrambled by a G-CS-RNTI, unicast SPS grant, or scheduling scrambled by a CS-RNTI. The second indication information indicates at least one of: a priority relationship between scheduling scrambled by different G-RNTIs, a priority relationship between different MBS SPS grants, or a priority relationship between scheduling scrambled by different G-CS-RNTIs.

In some optional implementations, the first information is used by the network device to perform data scheduling.

Those of skill in the art may understand that, related illustration of the apparatus for MG enhancement above in embodiments of the disclosure may refer to the related illustration of the method for information determination above in embodiments of the disclosure.

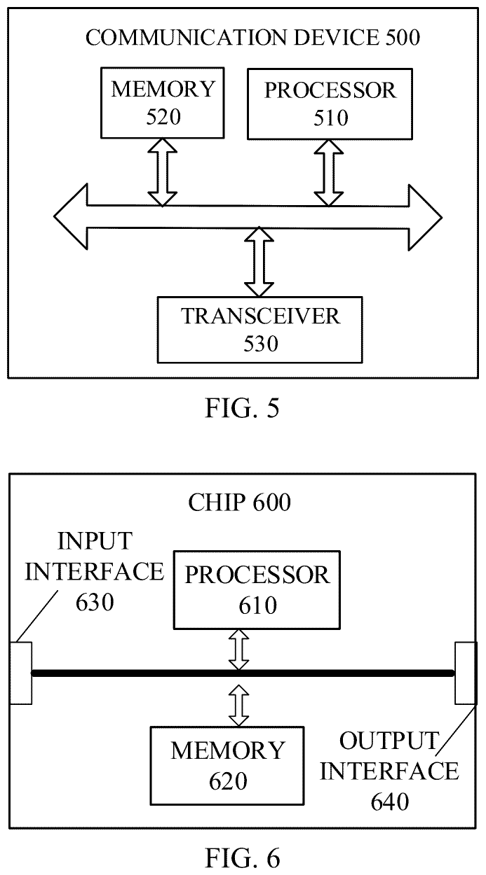

FIG. 5 is a schematic structural diagram of a communication device 500 provided in embodiments of the disclosure. The communication device may be applied to a terminal device. The communication device 500 illustrated in FIG. 5 includes a processor 510. The processor 510 may be configured to invoke and run computer programs from a memory to perform the method in embodiments of the disclosure.

Optionally, as illustrated in FIG. 5, the communication device 500 may further include a memory 520. The processor 510 may be configured to invoke and run computer programs from the memory 520 to perform the method in embodiments of the disclosure.

The memory 520 may be a separate device independent of the processor 510, or may be integrated into the processor 510.

Optionally, as illustrated in FIG. 5, the communication device 500 may further include a transceiver 530. The processor 510 can control the transceiver 530 to communicate with other devices. Specifically, the transceiver 530 can transmit information or data to other devices, or receive information or data transmitted by other devices.

The transceiver 530 may include a transmitter and a receiver. The transceiver 530 may further include one or more antennas.

The communication device 500 may specifically be the terminal device in the embodiments of the disclosure, and the communication device 500 can implement the corresponding process implemented by the terminal device in each of the methods of the embodiments of the disclosure, which will not be repeated herein for the sake of simplicity.

FIG. 6 is a schematic structural diagram of a chip in embodiments of the disclosure. The chip 600 illustrated in FIG. 6 includes a processor 610. The processor 610 is configured to invoke and run computer programs from a memory to perform the method in embodiments of the disclosure.

Optionally, as illustrated in FIG. 6, the chip 600 may further include a memory 620. The processor 610 may be configured to invoke and run computer programs from the memory 620 to perform the method in embodiments of the disclosure.

The memory 620 may be a separated device independent of the processor 610, or may be integrated into the processor 610.

Optionally, the chip 600 may further include an input interface 630. The processor 610 can control the input interface 630 to communicate with other devices or chips. Specifically, the input interface 630 can obtain information or data transmitted by other devices or chips.

Optionally, the chip 600 may further include an output interface 640. The processor 610 can control the output interface 640 to communicate with other devices or chips. Specifically, the output interface 640 can output information or data to other devices or chips.

The chip may be applied to the terminal device in embodiments of the disclosure, and the chip can implement the corresponding process implemented by the terminal device in each of the methods in the embodiments of the disclosure, which will not be repeated herein for the sake of simplicity.

It may be understood that, the chip mentioned in the embodiments of the disclosure may also be referred to as a system-level chip, a system chip, a chip system, a system-on-a-chip chip, or the like.

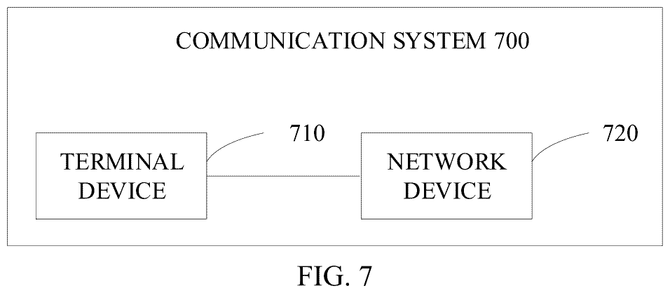

FIG. 7 is a schematic block diagram illustrating a communication system 700 provided in embodiments of the disclosure. As illustrated in FIG. 7, the communication system 700 includes a terminal device 710 and a network device 720.

The terminal device 710 can be configured to implement the corresponding functions implemented by the terminal device in the method above, and the network device 720 can be configured to implement the corresponding functions implemented by the network device in the method above, which will not be repeated herein for the sake of simplicity.

It may be understood that, the processor in embodiments of the disclosure may be an integrated circuit chip with signal processing capabilities. During implementation, each step of the foregoing method may be completed by an integrated logic circuit of hardware in the processor or an instruction in the form of software. The processor may be a general-purpose processor, a digital signal processor (DSP), an application specific integrated circuit (ASIC), a field programmable gate array (FPGA), or other programmable logic devices, discrete gates or transistor logic devices, discrete hardware components. The methods, steps, and logic blocks disclosed in embodiments can be implemented or executed. The general purpose processor may be a microprocessor, or the processor may be any conventional processor or the like. The steps of the method disclosed in embodiments may be directly implemented as a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the above-mentioned method with the hardware thereof.

It may be understood that, the memory may be a volatile memory or a non-volatile memory, or may include both the volatile memory and the non-volatile memory. The non-volatile memory may be an ROM, a PROM, an erasable PROM (EPROM), an electrically EPROM (EEPROM), or a flash memory. The volatile memory can be an RAM that acts as an external cache. By way of example but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). The memory of the system and the method described herein is intended to include, but is not limited to, these and any other suitable types of memory.

It may be understood that, the above description of the memory is intended for illustration rather than limitation. For example, the memory of embodiments may also be an SRAM, a DRAM, an SDRAM, a DDR SDRAM, an ESDRAM, an SLDRAM, a DR RAM, and so on. In other words, the memory of embodiments is intended to include, but is not limited to, these and any other suitable types of memory.

A computer-readable storage medium is further provided in embodiments of the disclosure. The computer readable storage medium is configured to store computer programs. The computer readable storage medium is applicable to the terminal device of embodiments. The computer programs are operable with a computer to implement the operations performed by the terminal device described in the foregoing method embodiments, which will not be repeated herein for the sake of simplicity.

A computer program product is further provided in embodiments of the disclosure. The computer program product includes computer program instructions. The computer program product is applicable to the terminal device of embodiments. The computer program instructions are operable with a computer to implement the operations performed by the terminal device described in the foregoing method embodiments, which will not be repeated herein for the sake of simplicity.

A computer program is further provided in embodiments of the disclosure. The computer program is applicable to the terminal device of embodiments. The computer program is operable with a computer to implement the operations performed by the terminal device described in the foregoing method embodiments, which will not be repeated herein for the sake of simplicity.

Those of ordinary skill in the art will appreciate that units and algorithmic operations of various examples described in connection with embodiments herein can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods may not be regarded as lying beyond the scope of the disclosure.

It will be evident to those skilled in the art that, for the sake of convenience and simplicity, in terms of the working processes of the foregoing systems, apparatuses, and units, reference can be made to the corresponding processes of the above method embodiments, which will not be repeated herein.

It will be appreciated that the systems, apparatuses, and methods disclosed in embodiments herein may also be implemented in various other manners. For example, the above apparatus embodiments are merely illustrative, e.g., the division of units is only a division of logical functions, and there may exist other manners of division in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interface, device or unit, and may be electrical, mechanical, or otherwise.

Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the disclosure.

In addition, various functional units described in embodiments herein may be integrated into one processing unit or may be present as a number of physically separated units, and two or more units may be integrated into one.

If the functions are implemented as software functional units and sold or used as standalone products, they may be stored in a computer readable storage medium. Based on such an understanding, the essential technical solution, or the portion that contributes to the prior art, or all or part of the technical solution of the disclosure may be embodied as software products. The computer software products can be stored in a storage medium and may include multiple instructions that, when executed, can cause a computing device, e.g., a personal computer, a server, a network device, etc., or a processor to execute some or all operations of the methods described in various embodiments. The above storage medium may include various kinds of media that can store program codes, such as a universal serial bus (USB) flash disk, a mobile hard drive, an ROM, an RAM, a magnetic disk, or an optical disk.

The above are merely specific embodiments of the disclosure and are not intended to limit the scope of protection of the disclosure. Any modification and replacement made by those skilled in the art within the technical scope of the disclosure shall be included in the scope of protection of the disclosure. Therefore, the scope of protection of the disclosure may be stated in the scope of protection of the claims.

What is claimed is:

1. A method for information determination, comprising:
receiving, by a terminal device, first scheduling signaling, the first scheduling signaling being scrambled by a first radio network temporary identity (RNTI), the first scheduling signaling carrying a hybrid automatic repeat request (HARQ) process identifier (ID) and a new data indication (NDI); and
determining, by the terminal device according to the first RNTI and/or a previous scheduling mode corresponding to the HARQ process ID, whether the NDI is toggled and/or a value of the NDI.

2. The method of claim 1, wherein determining, by the terminal device according to the first RNTI and/or the previous scheduling mode corresponding to the HARQ process ID, whether the NDI is toggled and/or the value of the NDI, comprises:
determining, by the terminal device, that the NDI is toggled, in a case that the first RNTI is a cell-RNTI (C-RNTI) and the previous scheduling mode corresponding to the HARQ process ID is scheduling scrambled by a group-RNTI (G-RNTI), multimedia broadcast service (MBS) semi-persistent scheduling (SPS) grant, or scheduling scrambled by a group-configured scheduling-RNTI (G-CS-RNTI).

3. The method of claim 1, wherein determining, by the terminal device according to the first RNTI and/or the previous scheduling mode corresponding to the HARQ process ID, whether the NDI is toggled and/or the value of the NDI, comprises:
determining, by the terminal device, that the NDI is toggled, in a case that the first RNTI is a G-RNTI and the previous scheduling mode corresponding to the HARQ process ID is MBS SPS grant, scheduling scrambled by a G-CS-RNTI, unicast SPS grant, or scheduling scrambled by a CS-RNTI.

4. The method of claim 1, wherein determining, by the terminal device according to the first RNTI and/or the previous scheduling mode corresponding to the HARQ process ID, whether the NDI is toggled and/or the value of the NDI, comprises:
determining, by the terminal device, that the NDI is toggled, in a case that the first RNTI is a CS-RNTI and the previous scheduling mode corresponding to the HARQ process ID is MBS SPS grant or scheduling scrambled by a G-CS-RNTI; or
determining, by the terminal device, that the NDI is un-toggled and/or the value of the NDI is fixed to 1, in the case that the first RNTI is the CS-RNTI.

5. The method of claim 1, wherein determining, by the terminal device according to the first RNTI and/or the previous scheduling mode corresponding to the HARQ process ID, whether the NDI is toggled and/or the value of the NDI, comprises:
determining, by the terminal device, that the NDI is toggled, in a case that the first RNTI is a first G-RNTI and the previous scheduling mode corresponding to the HARQ process ID is scheduling scrambled by a second G-RNTI.

6. The method of claim 1, wherein determining, by the terminal device according to the first RNTI and/or the previous scheduling mode corresponding to the HARQ process ID, whether the NDI is toggled and/or the value of the NDI, comprises:
determining, by the terminal device, that the NDI is toggled, in a case that the first RNTI is a first G-CS-RNTI and the previous scheduling mode corresponding to the HARQ process ID is scheduling scrambled by a second G-CS-RNTI or second MBS SPS grant; or
determining, by the terminal device, that the NDI is un-toggled and/or the value of the NDI is fixed to 1, in the case that the first RNTI is the first G-CS-RNTI.

7. The method of claim 1, further comprising:
transmitting, by the terminal device, first information to a network device, wherein the first information comprises first indication information and/or second indication information, wherein
the first indication information indicates a priority relationship between at least two of: scheduling scrambled by a C-RNTI, scheduling scrambled by a G-RNTI, MBS SPS grant, scheduling scrambled by a G-CS-RNTI, unicast SPS grant, or scheduling scrambled by a CS-RNTI; and
the second indication information indicates at least one of: a priority relationship between scheduling scrambled by different G-RNTIs, a priority relationship between
different MBS SPS grants, or a priority relationship between scheduling scrambled by different G-CS-RNTIs.

8. The method of claim 7, wherein the first information is used by the network device to perform data scheduling.

9. A terminal device, comprising:
a processor and a memory, wherein the memory is configured to store computer programs, which when executed by the processor, causes the terminal device to:
receive first scheduling signaling, the first scheduling signaling being scrambled by a first radio network temporary identity (RNTI), the first scheduling signaling carrying a hybrid automatic repeat request (HARQ) process identifier (ID) and a new data indication (NDI); and
determine, according to the first RNTI and/or a previous scheduling mode corresponding to the HARQ process ID, whether the NDI is toggled and/or a value of the NDI.

10. The terminal device of claim 9, wherein determining, according to the first RNTI and/or the previous scheduling mode corresponding to the HARQ process ID, whether the NDI is toggled and/or the value of the NDI, comprises:
determining that the NDI is toggled, in a case that the first RNTI is a cell-RNTI (C-RNTI) and the previous scheduling mode corresponding to the HARQ process ID is scheduling scrambled by a group-RNTI (G-RNTI), multimedia broadcast service (MBS) semi-persistent scheduling (SPS) grant, or scheduling scrambled by a group-configured scheduling-RNTI (G-CS-RNTI).

11. The terminal device of claim 9, wherein determining, according to the first RNTI and/or the previous scheduling mode corresponding to the HARQ process ID, whether the NDI is toggled and/or the value of the NDI, comprises:
determining that the NDI is toggled, in a case that the first RNTI is a G-RNTI and the previous scheduling mode corresponding to the HARQ process ID is MBS SPS grant, scheduling scrambled by a G-CS-RNTI, unicast SPS grant, or scheduling scrambled by a CS-RNTI.

12. The terminal device of claim 9, wherein determining, according to the first RNTI and/or the previous scheduling mode corresponding to the HARQ process ID, whether the NDI is toggled and/or the value of the NDI, comprises:
determining that the NDI is toggled, in a case that the first RNTI is a CS-RNTI and the previous scheduling mode corresponding to the HARQ process ID is MBS SPS grant or scheduling scrambled by a G-CS-RNTI; or
determining that the NDI is un-toggled and/or the value of the NDI is fixed to 1, in the case that the first RNTI is the CS-RNTI.

13. The terminal device of claim 9, wherein determining, according to the first RNTI and/or the previous scheduling mode corresponding to the HARQ process ID, whether the NDI is toggled and/or the value of the NDI, comprises:
determining that the NDI is toggled, in a case that the first RNTI is a first G-RNTI and the previous scheduling mode corresponding to the HARQ process ID is scheduling scrambled by a second G-RNTI.

14. The terminal device of claim 9, wherein determining, according to the first RNTI and/or the previous scheduling mode corresponding to the HARQ process ID, whether the NDI is toggled and/or the value of the NDI, comprises:
determining that the NDI is toggled, in a case that the first RNTI is a first G-CS-RNTI and the previous scheduling mode corresponding to the HARQ process ID is scheduling scrambled by a second G-CS-RNTI or second MBS SPS grant; or
determining that the NDI is un-toggled and/or the value of the NDI is fixed to 1, in the case that the first RNTI is the first G-CS-RNTI.

15. The terminal device of claim 9, wherein the computer programs, which when executed by the processor, further causes the terminal device to:
trasmit first information to a network device, wherein the first information comprises first indication information and/or second indication information;
wherein the first indication information indicates a priority relationship between at least two of: scheduling scrambled by a C-RNTI, scheduling scrambled by a G-RNTI, MBS SPS grant, scheduling scrambled by a G-CS-RNTI, unicast SPS grant, or scheduling scrambled by a CS-RNTI; and
wherein the second indication information indicates at least one of: a priority relationship between scheduling scrambled by different G-RNTIs, a priority relationship between different MBS SPS grants, or a priority relationship between scheduling scrambled by different G-CS-RNTIs.

16. The terminal device of claim 15, wherein the first information is used by the network device to perform data scheduling.

17. A chip, comprising:
a processor configured to exexute computer programs from a memory to enable a device equipped with the chip to:
receive first scheduling signaling, the first scheduling signaling being scrambled by a first radio network temporary identity (RNTI), the first scheduling signaling carrying a hybrid automatic repeat request (HARQ) process identifier (ID) and a new data indication (NDI); and
determine, according to the first RNTI and/or a previous scheduling mode corresponding to the HARQ process ID, whether the NDI is toggled and/or a value of the NDI.

18. The chip of claim 17, wherein determining, according to the first RNTI and/or the previous scheduling mode corresponding to the HARQ process ID, whether the NDI is toggled and/or the value of the NDI, comprises:
determining that the NDI is toggled, in a case that the first RNTI is a cell-RNTI (C-RNTI) and the previous scheduling mode corresponding to the HARQ process ID is scheduling scrambled by a group-RNTI (G-RNTI), multimedia broadcast service (MBS) semi-persistent scheduling (SPS) grant, or scheduling scrambled by a group-configured scheduling-RNTI (G-CS-RNTI).

19. The chip of claim 17, wherein determining, according to the first RNTI and/or the previous scheduling mode corresponding to the HARQ process ID, whether the NDI is toggled and/or the value of the NDI, comprises:
determining that the NDI is toggled, in a case that the first RNTI is a G-RNTI and the previous scheduling mode corresponding to the HARQ process ID is MBS SPS grant, scheduling scrambled by a G-CS-RNTI, unicast SPS grant, or scheduling scrambled by a CS-RNTI.

20. The chip of claim 17, wherein determining, according to the first RNTI and/or the previous scheduling mode corresponding to the HARQ process ID, whether the NDI is toggled and/or the value of the NDI, comprises:
determining that the NDI is toggled, in a case that the first RNTI is a first G-RNTI and the previous scheduling mode corresponding to the HARQ process ID is scheduling scrambled by a second G-RNTI.
